(19) United States
(12) Patent Application Publication
(10) Pub. No.: US 2026/0216810 A1
(43) Pub. Date: Jul. 30, 2026

(54) Multi-Layer Multi-Pass Welding Method and Apparatus, and Processor and Welding System

(71) Applicant: BEIJING BOTSING TECHNOLOGY CO.,LTD., Beijing (CN)

(72) Inventors: Xiaobing FENG, Beijing (CN); Aiping LIU, Beijing (CN); Baiwa PAN, Beijing (CN); Yanbei CHEN, Beijing (CN)

(21) Appl. No.: 19/147,556

(22) PCT Filed: Jan. 15, 2024
(86) PCT No.: PCT/CN2024/072370

§ 371 Date: Jul. 11, 2025

(30) Foreign Application Priority Data
Jan. 13, 2023 (CN) 202310081622.0

(51) Int. Cl. B23K 9/095; B23K 9/02; B23K 9/127

(52) U.S. Cl. CPC B23K 9/0956; B23K 9/0216; B23K 9/0953; B23K 9/1274

(57) ABSTRACT

Provided in the present disclosure are a multi-layer multi-pass welding method and apparatus, and a processor and a welding system. The method includes: before welding an ith weld layer of a weld seam, determining a first welding strategy for the ith weld layer according to a first weld seam image, welding paths of the weld passes, and welding operation parameters, with i≥2 and i being an integer; according to the first welding strategy, controlling a welding device to weld at least one weld pass of the ith weld layer; according to a second weld seam image, adjusting the first welding strategy corresponding to a current weld pass of the ith weld layer, so as to obtain a second welding strategy, and according to the second welding strategy, controlling the welding device to weld the current weld pass.

### CROSS-REFERENCE TO RELATED APPLICATION

The disclosure claims priority to Chinese Patent Application No. 2023100816220 filed to the China National Intellectual Property Administration on Jan. 13, 2023 and entitled “Multi-Layer Multi-Pass Welding Method and Apparatus, and Processor and Welding System”, the disclosure of which is hereby incorporated by reference in its entirety.

### TECHNICAL FIELD

The present disclosure relates to the field of welding, and specifically, to a multi-layer multi-pass welding method and apparatus, and a computer-readable storage medium, a processor and a welding system.

### BACKGROUND

The welding of thick plates for large structural components has a wide range of applications. Traditional manual welding and semi-automatic welding methods such as track trolleys and gantry cranes are no longer sufficient to meet the requirements for efficient and high-quality welding. The current multi-layer and multi-pass welding methods primarily relies on establishing geometric models with fixed groove angles based on different groove shapes of the workpieces. On this basis, the simplified models (triangular, trapezoidal, parallelogram, etc.) of welding passes, filling strategies (an equal height strategy, an equal area strategy, an arithmetic sequence strategy, etc.), calculation of start and end point coordinates of a weld pass path, and welding gun posture planning are performed. Such method of pre-planning welding paths and layout rules is difficult to adapt to changes in gaps caused by mechanical processing and assembly of welding members themselves. Furthermore, thermal deformation occurs during welding, especially it is difficult to match an actual welding trajectory with a planned layer strategy caused by too many weld passes or weld seam stacking, and it is difficult to ensure welding quality due to increased cumulative errors, thus making it difficult to solve the practical problem of the welding of large structural components.

### SUMMARY

In order to implement the above objective, an aspect of the present disclosure provides a multi-layer multi-pass welding method, including: a first determination step: before welding an ith weld layer of a weld seam, a first welding strategy for the ith weld layer is determined according to a first weld seam image, where the first weld seam image is a weld seam image after an (i−1)th weld layer is welded, and the first welding strategy includes the number of weld passes of a weld layer, welding paths of the weld passes, and welding operation parameters, with i≥2 and i being an integer; a first control step: according to the first welding strategy, a welding device is controlled to weld at least one weld pass of the ith weld layer; a first adjustment step: according to a second weld seam image, the first welding strategy corresponding to a current weld pass of the ith weld layer is adjusted, so as to obtain a second welding strategy, where the current weld pass is the weld pass to be welded, and the second weld seam image is a weld seam image after a previous weld pass of the current weld pass is welded; and a second control step: according to the second welding strategy, the welding device is controlled to weld the current weld pass.

Optionally, the first determination step includes: according to the first weld seam image, angle information of grooves of remaining weld seam, an internal height of the remaining weld seam, the number of target weld passes, an area to be filled of each target weld pass, and a height of each target weld pass are determined, where the remaining weld seam are the weld seams filled with the (i−1)th weld layer, the target weld pass is the weld pass in the ith weld layer, and the number of the target weld passes is the quantity of the target weld passes; a target inflection point is used as a coordinate origin point to establish a coordinate system, and according to an initial internal height, a root gap of the weld seam, the angle information, the internal height of the remaining weld seam, the number of the target weld passes, the area to be filled of the target weld pass, and the height of the target weld pass, the welding path of each of the target weld passes, including a welding start point coordinate and a welding end point coordinate, is determined, where the target inflection point is one of two groove inflection points of the weld seam, and the initial internal height is the internal height of the weld seam before multi-layer multi-pass welding; and according to the area to be filled of the target weld pass, a welding speed range of the welding device, and a wire feeding speed range, the welding operation parameters of each of the target weld passes are determined, so as to obtain the first welding strategy.

Optionally, according to the first weld seam image, determining the angle information of the grooves of the remaining weld seam, the internal height of the remaining weld seam, the number of the target weld passes, the area to be filled of each target weld pass, and the height of each target weld pass includes: according to the first weld seam image, the angle information including a left groove angle and a right groove angle, and the internal height of the remaining weld seam are determined; according to the internal height of the remaining weld seam and a weld reinforcement, welding heights of the remaining weld seam are determined as a first height, and according to the first height, a maximum penetration depth for each weld, and a minimum penetration depth for each weld, the number of weld layers of the remaining weld seam is determined; according to the first height and the number of the weld layers of the remaining weld seam, a welding height of the ith weld layer is determined as the height of each target weld pass, and according to the height of the target weld pass, the left groove angle, and the right groove angle, an area to be filled of the ith weld layer is determined; and according to the area to be filled of the ith weld layer, a maximum deposition area for each weld, and a minimum deposition area, the number of the target weld passes and the area to be filled of each target weld pass are determined.

Optionally, in the first welding strategy, the last target weld pass of the ith weld layer is a trapezoidal weld pass, and the target weld passes other than the last target weld pass are parallelogram weld passes. According to the initial internal height, the root gap of the weld seam, the angle information, the internal height of the remaining weld seam, the number of the target weld passes, the area to be filled of the target weld pass, and the height of the target weld pass, determining the welding path of each of the target weld passes, including the welding start point coordinate and the welding end point coordinate, includes: according to the area to be filled of the target weld pass and the height of the target weld pass, a bottom edge length of each parallelogram weld pass is determined to be dᵢ=S′ᵢ/hₖᵢ, where dᵢ is the bottom edge length of each parallelogram weld pass, S′ᵢ is the area to be filled of the target weld pass, and hₖᵢ is the height of the target weld pass; according to the bottom edge length of each parallelogram weld pass, the initial internal height, the root gap, the angle information, the internal height of the remaining weld seam, and the number of the target weld passes, a lower edge length of the trapezoidal weld pass is determined to be d_{ib}=g+(tan_{α}+tan_{β})×(H−hₖ)−(nᵢ−1)×dᵢ, where d_{ib} is the lower edge length, α is a left groove angle, β is a right groove angle, the left groove angle and the right groove angle constitute the angle information, H is the initial internal height, hₖ is the internal height of the remaining weld seam, and nᵢ is the number of the target weld passes; according to the bottom edge length of each parallelogram weld pass, the initial internal height, the root gap, the angle information, the internal height of the remaining weld seam, the height of the target weld pass, and the number of the target weld passes, an upper edge length of the trapezoidal weld pass is determined to be dᵢₜ=g+(tan α+tan β)×(H−hₖ+hₖᵢ)−(nᵢ−1)×dᵢ, where dᵢₜ is the upper edge length, and hₖᵢ is the height of the target weld pass; and according to each bottom edge length, the upper edge length, and the lower edge length, the welding start point coordinate and the welding end point coordinate corresponding to each target weld pass are determined.

Optionally, according to the area to be filled of the target weld passes, the welding speed range of the welding device, and the wire feeding speed range, determining the welding operation parameters of each of the target weld passes includes: a second determination step: a welding speed within the welding speed range is determined, and a wire feeding speed is determined according to the area to be filled of the target weld passes, the welding speed, and a formula

$${S}_{i} = \frac{π {D}^{2} Fa}{4 V} ,$$

where Sᵢ is the area to be filled of the target weld pass, V is the welding speed, F is the wire feeding speed, D is a welding wire diameter, and a is a preset deposition coefficient; a second adjustment step: when the wire feeding speed is not within the wire feeding speed range, the wire feeding speed is adjusted to the wire feeding speed range, so as to obtain the adjusted wire feeding speed, and according to the adjusted wire feeding speed, the area to be filled of the target weld pass, and the formula

$${S}_{i} = \frac{π {D}^{2} Fa}{4 V} ,$$

the welding speed is adjusted to obtain the adjusted welding speed; and a repetition step: when the adjusted welding speed is not within the welding speed range, the second determination step and the second adjustment step are sequentially executed for at least once, until the adjusted wire feeding speed is within the wire feeding speed range, and the adjusted welding speed is within the welding speed range.

Optionally, the second control step includes: a first control sub-step: according to the second welding strategy, the welding device is controlled to weld the current weld pass, wherein the welded current weld pass is the previous weld pass; a determination sub-step: whether the previous weld pass is the last weld pass of the ith weld layer is determined; and a repetition sub-step: when the previous weld pass is not the last weld pass, the first adjustment step, the first control sub-step, and the determination sub-step are sequentially executed for at least once, until the previous weld pass is the last weld pass.

Optionally, the first adjustment step includes: according to the second weld seam image, the remaining area to be filled of the ith weld layer is determined as a target area and the height of the welded weld pass of the ith weld layer is determined as a first target height; a second target height is determined as a maximum value among the first target heights, where the second target height is a welding height of the remaining weld passes of the ith weld layer; according to the target area and the second target height, the number of the weld passes remaining in the ith weld layer, welding paths of the remaining weld passes, and the welding operation parameters of the remaining weld passes are determined, so as to obtain target parameters; and corresponding parameters in the first welding strategy are modified as the target parameters, so as to obtain the second welding strategy.

Optionally, the ith weld layer is a filling layer or capping layer of the weld seam.

Optionally, the first control step includes: the welding device is controlled to operate according to the welding operation parameters, and to weld the 1st weld pass of the ith weld layer along the welding path from the welding start point coordinate.

Optionally, before the first determination step, the method further includes: an initial welding strategy is established according to weld seam size information of the weld seam before multi-layer multi-pass welding, where the initial welding strategy includes the number of weld layers of the weld seam, the number of weld passes of the weld seam, the welding path of each weld pass of the weld seam, and the welding operation parameters of each weld pass of the weld seam. The first determination step includes: before the ith weld layer of the weld seam is welded, the initial welding strategy is adjusted according to the first weld seam image, so as to obtain the first welding strategy.

Another aspect of the present disclosure provides a multi-layer multi-pass welding apparatus, including: a determination unit, configured to perform a first determination step: before welding an ith weld layer of a weld seam, a first welding strategy for the ith weld layer is determined according to a first weld seam image, where the first weld seam image is a weld seam image after an (i−1)th weld layer is welded, and the first welding strategy includes the number of weld passes of a weld layer, welding paths of the weld passes, and welding operation parameters, with i≥2 and i being an integer; a first control unit, configured to perform a first control step: according to the first welding strategy, a welding device is controlled to weld at least one weld pass of the ith weld layer; an adjustment unit, configured to perform a first adjustment step: according to a second weld seam image, the first welding strategy corresponding to a current weld pass of the ith weld layer is adjusted, so as to obtain a second welding strategy, where the current weld pass is the weld pass to be welded, and the second weld seam image is a weld seam image after a previous weld pass of the current weld pass is welded; and a second control unit, configured to perform a second control step: according to the second welding strategy, the welding device is controlled to weld the current weld pass.

Yet another aspect of the present disclosure provides a computer-readable storage medium. The computer-readable storage medium includes a stored program. When the program is operated, a device where the computer-readable storage medium is located is controlled to execute any one of the methods.

Still another aspect of the present disclosure provides a processor. The processor is configured to operate a program. Any one of the methods is executed when the program is operated.

Another aspect of the present disclosure further provides a welding system, including: a welding device; and a controller of the welding device. The controller is communicatively connected or electrically connected to the welding device, and includes one or more processors, a memory, and one or more programs, where the one or more programs are stored in the memory, and are configured to be executed by the one or more processors; and the one or more programs include instructions for executing any one of the methods.

### BRIEF DESCRIPTION OF THE DRAWINGS

The accompanying drawings constituting a part of the present disclosure are used to provide a further understanding of the present disclosure. The exemplary embodiments of the present disclosure and the description thereof are used to explain the present disclosure, but do not constitute improper limitations to the present disclosure. In the drawings:

FIG. 1 is a block diagram of a hardware structure of a mobile terminal executing a multi-layer multi-pass welding method according to embodiments of the present disclosure.

FIG. 2 is a schematic flowchart of a multi-layer multi-pass welding method according to embodiments of the present disclosure.

FIG. 3 is a schematic diagram of a first weld seam image according to embodiments of the present disclosure.

FIG. 4 is a schematic diagram of establishment of a coordinate system using a target inflection point as a coordinate origin point according to embodiments of the present disclosure.

FIG. 5 is a schematic diagram of weld pass planning of an ith weld layer according to embodiments of the present disclosure.

FIG. 6 is a schematic diagram of a second weld seam image according to embodiments of the present disclosure.

FIG. 7 is a block structural diagram of a multi-layer multi-pass welding apparatus according to embodiments of the present disclosure.

The above drawings include the following reference numerals:
102. Processor; 104. Memory; 106. Transmission device; and 108. Input/output device.

### DETAILED DESCRIPTION OF THE EMBODIMENTS

It is to be noted that the embodiments in the present disclosure and the features in the embodiments can be combined with one another without conflict. The present disclosure will be described below in detail with reference to the drawings and the embodiments.

In order to enable those skilled in the art to better understand the solutions of the present disclosure, the technical solutions in the embodiments of the present disclosure will be clearly and completely described below in combination with the drawings in the embodiments of the present disclosure. It is apparent that the described embodiments are only part of the embodiments of the present disclosure, not all the embodiments. Based on the embodiments in the present disclosure, all other embodiments obtained by those of ordinary skill in the art without creative work shall all fall within the protection scope of the present disclosure.

It is to be noted that terms “first”, “second” and the like in the description, claims and the drawings of the present disclosure are used for distinguishing similar objects rather than describing a specific sequence or a precedence order. It should be understood that the data used in such a way can be exchanged where appropriate, in order that the embodiments of the present disclosure described here can be implemented. In addition, terms “include” and “have” and any variations thereof are intended to cover non-exclusive inclusions. For example, it is not limited for processes, methods, systems, products or devices containing a series of steps or units to clearly list those steps or units, and other steps or units which are not clearly listed or are inherent to these processes, methods, products or devices can be included instead.

As introduced in the Background, the one-time planning of a layer strategy for multi-layer multi-pass welding in the related art cannot adapt to subsequent weld changes, leading to a poor actual welding effect. In order to solve the above problem, embodiments of the present disclosure provide a multi-layer multi-pass welding method and apparatus, and a computer-readable storage medium, a processor and a welding system.

The technical solutions in the embodiments of the present disclosure will be clearly and completely described below with reference to the accompanying drawings in the embodiments of the present disclosure.

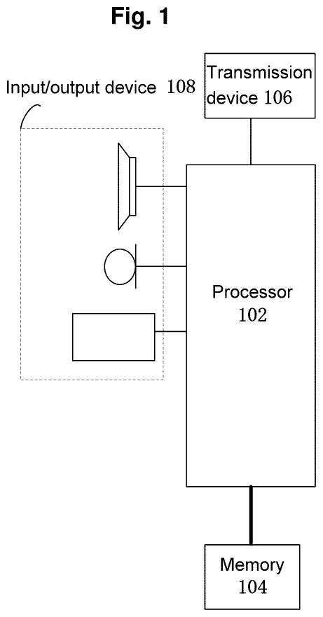

The method embodiments provided in the embodiments of the present disclosure can be executed in a mobile terminal, a computer terminal or a similar computing apparatus. By being operated on the mobile terminal as an example, FIG. 1 is a block diagram of a hardware structure of a mobile terminal of a multi-layer multi-pass welding method according to embodiments of the present disclosure. As shown in FIG. 1, the mobile terminal can include one or more (only one is shown in FIG. 1) processors 102 (the processor 102 can include, but is not limited to, a processing apparatus such as a microprocessor MCU or a programmable logic device FPGA) and a memory 104 for storing data. The mobile terminal can further include a transmission device 106 for achieving a communication function and an input/output device 108. Those skilled in the art can understand that the structure shown in FIG. 1 is only a schematic diagram, which does not limit the structure of the mobile terminal. For example, the mobile terminal can also include more or less components than those shown in FIG. 1, or have a different configuration from that shown in FIG. 1.

The memory 104 can be configured to store a computer program, for example, a software program and a module of application software, such as a computer program corresponding to a multi-Layer multi-pass welding method in the embodiments of the present disclosure. The processor 102 runs the computer program stored in the memory 104, so as to execute various functional applications and data processing, that is, to realize the method. The memory 104 can include a high-speed random access memory, and can further include a non-volatile memory, such as one or more magnetic disk memory apparatuses, a flash memory device, or other non-volatile solid-state memory devices. In some embodiments, the memory 104 can further include memories remotely disposed relative to the processor 102. The remote memories can be connected to the mobile terminal by using a network. Examples of the network include, but are not limited to, the Internet, an intranet, a local area network, a mobile communication network, and a combination thereof. The transmission device 106 is configured to receive or transmit data via a network. The specific example of the network can include a wireless network provided by a communication provider of the mobile terminal. In an example, the transmission device 106 includes a Network Interface Controller (NIC), and can be connected to other network devices by using a base station, so as to communicate with the Internet. In an example, the transmission device 106 is a Radio Frequency (RF) module, which is configured to communicate with the Internet in a wireless manner.

This embodiment provides a multi-layer multi-pass welding method that is operated in a mobile terminal, a computer terminal, or a similar computing apparatus. It is to be noted that the steps shown in the flow diagram of the accompanying drawings can be executed in a computer system, such as a set of computer-executable instructions, and although a logical sequence is shown in the flow diagram, in some cases, the steps shown or described can be executed in a different order than here.

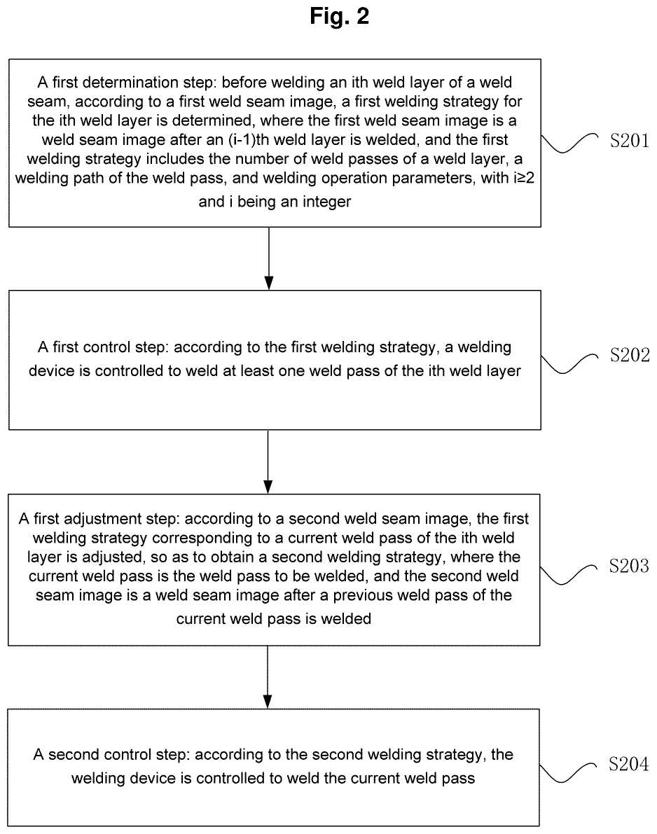

FIG. 2 is a flowchart of a multi-layer multi-pass welding method according to embodiments of the present disclosure. As shown in FIG. 2, the method includes the following steps.

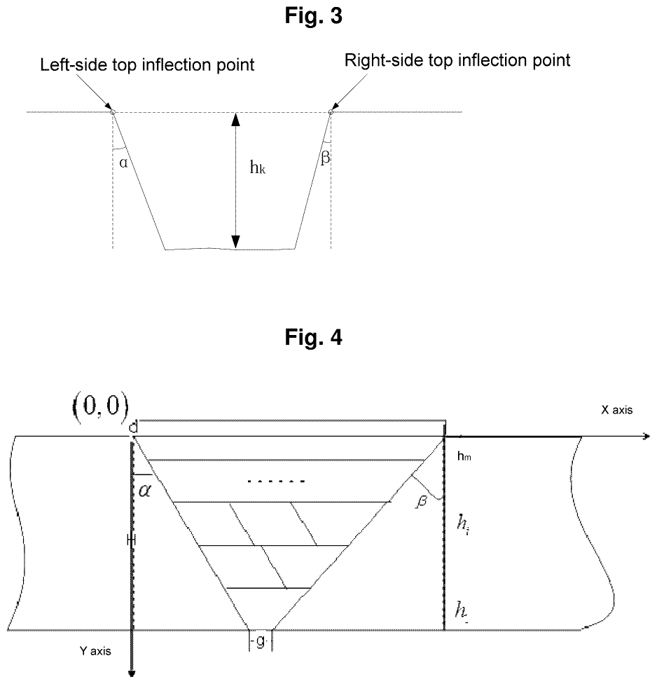

At S201, namely, a first determination step: before welding an ith weld layer of a weld seam, according to a first weld seam image as shown in FIG. 3, a first welding strategy for the ith weld layer is determined, where the first weld seam image is a weld seam image after an (i−1)th weld layer is welded, and the first welding strategy includes the number of weld passes of a weld layer, a welding path of the weld pass, and welding operation parameters, with i≥2 and i being an integer.

Specifically, the welding operation parameters include a welding speed, a wire feeding speed, and a heat input amount. Definitely, in addition to the welding speed, the wire feeding speed, and the heat input amount, operation parameters such as a welding current, a welding voltage, and a welding gun swing can further be included, and the wire feeding speed is directly related to the welding current, the welding voltage, and the heat input amount. The welding path is a path including a welding start point coordinate and a welding end point coordinate.

In an optional embodiment, the first determination step specifically includes the following step.

At S2011, according to the first weld seam image, angle information of grooves of remaining weld seam, an internal height of the remaining weld seam, the number of target weld passes, an area to be filled of each target weld pass, and a height of each target weld pass are determined, where the remaining weld seam are the weld seams filled with the (i−1)th weld layer, the target weld pass is the weld pass in the ith weld layer, and the number of the target weld passes is the quantity of the target weld passes.

Specifically, the internal height of the remaining weld seam is a depth of the remaining weld seam, and does not include a weld reinforcement. In order to ensure a post-welding formation effect, the heights of all weld passes of each weld layer remain the same, that is to say, the height of each target weld pass is the same.

It is to be noted that, the first weld seam image is acquired when an image acquisition device of the welding device directly targets the remaining weld seam and a laser obliquely targets the remaining weld seam, that is, an optical axis of the image acquisition device is vertical to groove surfaces of the remaining weld seam, and a laser line of the laser is at an acute angle to the groove surfaces of the remaining weld seam. In an optical embodiment, the acute angle can be 45°. The present disclosure selects the manner of oblique targeting of the laser and direct targeting of the image acquisition device, which is very suitable for multi-layer multi-pass welding processing based on a laser image, and weld seam shapes and a proportional relationship can be acquired from the image.

Further, according to the first weld seam image, determining the angle information of the grooves of the remaining weld seam, the internal height of the remaining weld seam, the number of the target weld passes, the area to be filled of each target weld pass, and the height of each target weld pass includes: according to the first weld seam image, the angle information including a left groove angle and a right groove angle, and the internal height of the remaining weld seam are determined; according to the internal height of the remaining weld seam and a weld reinforcement, welding heights of the remaining weld seam are determined as a first height, and according to the first height, a maximum penetration depth for each weld, and a minimum penetration depth for each weld, the number of weld layers of the remaining weld seam is determined; according to the first height and the number of the weld layers of the remaining weld seam, a welding height of the ith weld layer is determined as the height of each target weld pass, and according to the height of the target weld pass, the left groove angle, and the right groove angle, an area to be filled of the ith weld layer is determined; and according to the area to be filled of the ith weld layer, a maximum deposition area for each weld, and a minimum deposition area, the number of the target weld passes and the area to be filled of each target weld pass are determined.

The left groove angle is an included angle between a groove surface of a left groove and a vertical direction; the right groove angle is an included angle between a groove surface of a right groove and the vertical direction; the first height is a sum of the internal height of the remaining weld seam and the weld reinforcement; and the maximum penetration depth for each weld and the minimum penetration depth can be predetermined according to parameters of the welding device itself.

During actual application, according to the first weld seam image, determining the angle information including the left groove angle and the right groove angle, and the internal height of the remaining weld seam can be implemented as follows: centerline extraction is performed on the first weld seam image to obtain a laser centerline, coordinates of two bottom inflection points in the image, and coordinates of two top inflection points in the image; according to the laser centerline, the coordinates of the two bottom inflection points in the image, and the coordinates of the two top inflection points in the image, the left groove angle, the right groove angle, a spacing between the two top inflection points in the image, and the area to be filled of the remaining weld seam in the image are determined; according to the left groove angle, the right groove angle, the spacing between the two top inflection points in the image, and the area to be filled of the remaining weld seam in the image, a numerical value of the internal height of the remaining weld seam in the image is determined; and coordinate system conversion is performed on the numerical value to obtain the internal height of the remaining weld seam, where the coordinate system conversion includes converting an image coordinate system into a camera coordinate system, and then converting the camera coordinate system into world coordinates.

In an exemplary embodiment, since an interface of the remaining weld seam in a width direction of the weld seam can be equivalent to a trapezoid, according to the left groove angle, the right groove angle, the spacing between the two top inflection points in the image, and the area to be filled of the remaining weld seam in the image, the numerical value of the internal height in the image is determined, which is actually a process of calculating the height of the trapezoid. The height can be calculated through deformation using an area formula of the trapezoid: area=½×(upper bottom edge of trapezoid+lower bottom edge of trapezoid)×height. The upper bottom edge of the trapezoid and the lower bottom edge of the trapezoid are obtained by performing trigonometric function calculation on the left groove angle, the right groove angle, and the spacing between the two top inflection points in the image.

Furthermore, according to the first height, the maximum penetration depth for each weld, and the minimum penetration depth, determining the number of the weld layers of the remaining weld seam can specifically be implemented as follows: a value range of the number of the weld layers is determined according to the first height, the maximum penetration depth, and the minimum penetration depth, and then an integer value is determined from the value range as the number of the weld layers. In order to simplify calculation, based on the equal height principle of each weld layer, and according to the first height and the number of the weld layers of the remaining weld seam, the welding height of the ith weld layer is determined as the height of each target weld pass, which is actually a process of, according to the first height and the number of the weld layers of the remaining weld seam, determining an average welding height of each weld layer. Since a cross section of each weld layer in the width direction of the weld seam can also be equivalent to the trapezoid, determining the area to be filled of the ith weld layer according to the height of the target weld pass, the left groove angle, and the right groove angle is actually a process of calculating an area of the trapezoid. According to the area to be filled of the ith weld layer, the maximum deposition area for each weld, and the minimum deposition area, determining the number of the target weld passes and the area to be filled of each target weld pass can be implemented as follows: according to the area to be filled of the ith weld layer, the maximum deposition area for each weld, and the minimum deposition area, a value range of the number of the target weld passes is determined; then an integer value is determined as the number of the target weld passes from the value range of the number of the target weld passes; and based on an equal area principle of each target weld pass, and according to the area to be filled of the ith weld layer, and the number of the target weld passes, the area to be filled of each target weld pass is determined.

Definitely, the manner of, according to the first weld seam image, determining the angle information of the grooves of the remaining weld seam, the internal height of the remaining weld seam, the number of the target weld passes, the area to be filled of each target weld pass, and the height of each target weld pass is not limited to an enumerative manner. Those skilled in the art can flexibly select an appropriate manner to calculate the angle information of the grooves of the remaining weld seam, the internal height of the remaining weld seam, the number of the target weld passes, the area to be filled of each target weld pass, and the height of each target weld pass based on size and position information extracted from the first weld seam image according to actual situations.

At S2012, as shown in FIG. 4, a target inflection point is used as a coordinate origin point to establish a coordinate system, and according to an initial internal height, a root gap of the weld seam, the angle information, the internal height of the remaining weld seam, the number of the target weld passes, the area to be filled of the target weld pass, and the height of the target weld pass, the welding path of each of the target weld passes, including a welding start point coordinate and a welding end point coordinate, is determined, where the target inflection point is one of two groove inflection points of the weld seam, and the initial internal height is the internal height of the weld seam before multi-layer multi-pass welding.

Specifically, the groove inflection point is a top inflection point of the groove.

FIG. 4 shows that a coordinate position of each weld pass, as well as a boundary point of each layer and each pass, bottom overlap points and the like, are determined by using a left-side top inflection point of the groove as an original point, using an x-axis direction as a direction from the left-side top inflection point to a right-side top inflection point, and using a y-axis direction as a direction (a direction perpendicular to the groove) in which the left-side top inflection point points toward the bottom of the groove.

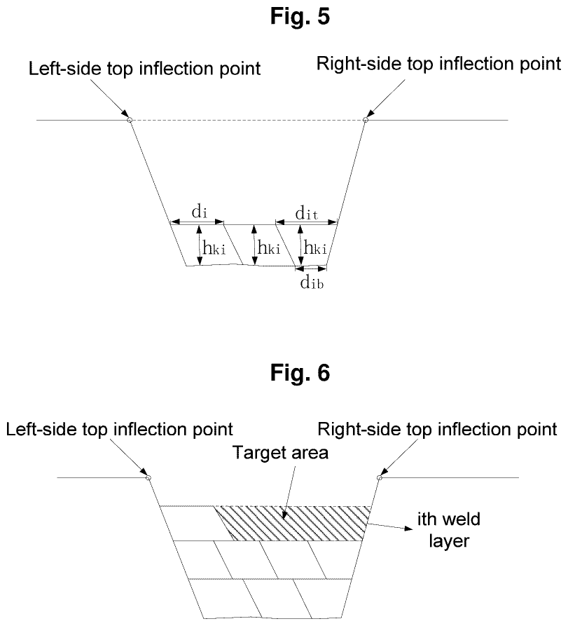

Further, as shown in FIG. 5, in the first welding strategy, the last target weld pass of the ith weld layer is a trapezoidal weld pass, and the target weld passes other than the last target weld pass are parallelogram weld passes. A specific process of S2012 includes as follows.

At S20121, according to the area to be filled of the target weld pass and the height of the target weld pass, a bottom edge length of each parallelogram weld pass is determined to be dᵢ=S′ᵢ/hₖᵢ, where dᵢ is the bottom edge length of each parallelogram weld pass, S′ᵢ is the area to be filled of the target weld pass, and hₖᵢ is the height of the target weld pass.

At S20122, according to the bottom edge length of each parallelogram weld pass, the initial internal height, the root gap, the angle information, the internal height of the remaining weld seam, and the number of the target weld passes, a lower edge length of the trapezoidal weld pass is determined to be d_{ib}=g+(tan α+tan β)×(H−hₖ)−(nᵢ−1)×dᵢ, where d_{ib} is the lower edge length, α is a left groove angle, β is a right groove angle, the left groove angle and the right groove angle constitute the angle information, H is the initial internal height, hₖ is the internal height of the remaining weld seam, and nᵢ is the number of the target weld passes.

At S20123, according to the bottom edge length of each parallelogram weld pass, the initial internal height, the root gap, the angle information, the internal height of the remaining weld seam, the height of the target weld pass, and the number of the target weld passes, an upper edge length of the trapezoidal weld pass is determined to be dᵢₜ=g+(tan α+tan β)×(H−hₖ+hₖᵢ)−(nᵢ−1)×dᵢ, where dᵢₜ is the upper edge length, and hₖᵢ is the height of the target weld pass.

At S20124, according to each bottom edge length, the upper edge length, and the lower edge length, the welding start point coordinate and the welding end point coordinate corresponding to each target weld pass are determined.

In the embodiments, the welding start point coordinate and the welding end point coordinate of each weld pass are converted into upper and lower bottom edge lengths of each target weld pass through calculation, and then in the established coordinate system, the welding start point coordinate and the welding end point coordinate of each target weld pass are determined according to the upper and lower bottom edge lengths and the height, such that it ensures that a weld pass planning strategy suitable for the current weld layer can be obtained simply and accurately, the real-time performance and high accuracy of weld pass planning are further ensured, and an impact of welding changes on weld seam parameters is fully taken into consideration.

It is to be noted that, the last target weld pass of the ith weld layer being the trapezoidal weld pass means that the target weld pass is cut open in the width direction of the weld seam, a cross-sectional shape of the target weld pass is approximately a trapezoid, and the width direction is a direction connecting two top inflection points. The target weld passes other than the last target weld pass being parallelogram weld passes means that the target weld pass is cut open in the width direction of the weld seam, and the cross-sectional shape of the target weld pass is approximately a parallelogram.

At S2013, according to the area to be filled of the target weld pass, a welding speed range of the welding device, and a wire feeding speed range, the welding operation parameters of each of the target weld passes are determined, so as to obtain the first welding strategy.

In the specific implementation process of the first determination step, first, according to the first weld seam image, the angle information of the grooves of the remaining weld seam, the internal height of the remaining weld seam, and the ith weld layer are determined, that is, information such as the number of the weld passes of the current weld layer, the area to be filled of each weld pass, the height, etc.; then, one of the two groove inflection points is used as the coordinate origin point to establish the coordinate system, and based on the coordinate system, and according to the information determined from the first weld seam image and the internal height and root gap of the entire weld seam before welding, the welding path of each weld pass, including the welding start point coordinate and the welding end point coordinate, is determined; and finally, according to the area to be filled of the target weld pass, the welding speed range, and the wire feeding speed range, the welding operation parameters including the welding speed and the wire feeding speed are determined, so as to obtain the first welding strategy. Compared to the use of a bottom center of an original groove of a workpiece as a coordinate origin point, in an actual welding process of multi-layer multi-pass welding, with the proceeding of welding and filling, bottom information of the groove changes at any time, and the bottom center is present only when the first one among the weld passes of the weld seam is filled, causing the origin point to disappear during subsequent welding, thus leading to instability in multi-layer multi-pass models and strategies. In the present disclosure, the coordinate system is established by using the top inflection point as the coordinate origin point, and the path of each pass of each layer in the coordinate system is determined, such that the first welding strategy is updated in real time according to welding situations, thereby further realizing real-time adjustment of the layer-pass welding strategy for multi-layer multi-pass welding according to actual welding situations. Therefore, the real-time performance and accuracy of layer-pass planning are further ensured, and difficult adaption of the welding layer-pass strategy planned in advance to thermal deformation, groove changes, and uneven height fluctuations of a welding member during welding is further avoided.

In order to further realize the matching of the welding operation parameters of the welding device with the layer-pass welding strategy currently determined, in an optional solution, S2013 can be implemented as follows: a second determination step: a welding speed within the welding speed range is determined, and a wire feeding speed is determined according to the area to be filled of the target weld passes, the welding speed, and a formula

$${S}_{i} = \frac{π {D}^{2} Fa}{4 V} ,$$

where Sᵢ is the area to be filled of the target weld pass, V is the welding speed, F is the wire feeding speed, D is a welding wire diameter, and a is a preset deposition coefficient; a second adjustment step: when the wire feeding speed is not within the wire feeding speed range, the wire feeding speed is adjusted to the wire feeding speed range, so as to obtain the adjusted wire feeding speed, and according to the adjusted wire feeding speed, the area to be filled of the target weld pass, and the formula

$${S}_{i} = \frac{π {D}^{2} Fa}{4 V} ,$$

the welding speed is adjusted to obtain the adjusted welding speed; and a repetition step: when the adjusted welding speed is not within the welding speed range, the second determination step and the second adjustment step are sequentially executed for at least once, until the adjusted wire feeding speed is within the wire feeding speed range, and the adjusted welding speed is within the welding speed range.

In the embodiments of the present disclosure, the welding speed is fixed first to adjust the wire feeding speed, such that the adjusted wire feeding speed meets the wire feeding speed range, so as to ensure that a requirement for the heat input amount is met. When the wire feeding speed is adjusted, if the wire feeding speed exceeds the wire feeding speed range, causing the heat input amount to not meet the heat input amount range, the wire feeding speed meeting the heat input amount is then fixed to adjust the welding speed, until the welding speed and the wire feeding speed both meet the corresponding ranges, and the welding heat input amount meets the requirement through the repetition and adjustment processes, such that it further ensures that the welding operation parameters match the welding strategy of the current layer, thereby further ensuring a good welding effect.

The welding operation parameters of each weld pass need to be determined in a manner. Since the heat input amount meeting welding quality is a range and the wire feeding speed is directly related to the welding current, the welding voltage, and the heat input amount, through analysis of a large number of process parameters, the most stable and common welding speed is acquired as a fixed value, so as to adjust the wire feeding speed.

According to still another specific embodiment of the present disclosure, before the first determination step, the method further includes: an initial welding strategy is established according to weld seam size information of the weld seam before multi-layer multi-pass welding, where the initial welding strategy includes the number of weld layers of the weld seam, the number of weld passes of the weld seam, the welding path of each weld pass of the weld seam, and the welding operation parameters of each weld pass of the weld seam. The first determination step includes: before the ith weld layer of the weld seam is welded, the initial welding strategy is adjusted according to the first weld seam image, so as to obtain the first welding strategy. That is to say, in the present disclosure, before the weld seam is welded, the initial welding strategy is established according to an actual assembly situation of a workpiece, and the weld seam is welded based on the initial welding strategy; during welding, thermal deformation is taken into consideration, and shape features of the remaining weld seam are acquired in real time; and the initial welding strategy is adjusted according to the shape feature information, so as to obtain the first welding strategy matching a current shape feature. Therefore, it avoids the welding of the entire weld seam according to the initial welding strategy, resulting in excessive weld passes and weld seam stacking, thus making it difficult to match an actual welding trajectory with a planned start and end point coordinates, increasing cumulative errors, and making it difficult to ensure the welding quality.

At S202, namely a first control step: according to the first welding strategy, a welding device is controlled to weld at least one weld pass of the ith weld layer.

Specifically, according to the first welding strategy, only the last weld pass of the ith weld layer can be welded, or a plurality of weld passes of the ith weld layer can also be continuously welded in sequence according to the first welding strategy.

In another exemplary solution, the first control step includes: the welding device is controlled to operate according to the welding operation parameters, and to weld the 1st weld pass of the ith weld layer along the welding path from the welding start point coordinate.

At S203, namely a first adjustment step: according to a second weld seam image shown in FIG. 6, the first welding strategy corresponding to a current weld pass of the ith weld layer is adjusted, so as to obtain a second welding strategy, where the current weld pass is the weld pass to be welded, and the second weld seam image is a weld seam image after a previous weld pass of the current weld pass is welded.

Specifically, the second welding strategy also includes the number of weld passes of the weld layer, the welding path of the weld pass, and the welding operation parameters. The current weld pass is a jth weld pass of the ith weld layer; and the previous weld pass can be the 1st weld pass of the ith weld layer, or can also be a (j−1)th of the ith weld layer.

It is to be noted that, the second weld seam image is also acquired when an image acquisition device of the welding device directly targets the remaining weld seam and a laser obliquely targets the remaining weld seam, that is, an optical axis of the image acquisition device is vertical to groove surfaces of the remaining weld seam, and a laser line of the laser is at an acute angle to the groove surfaces of the remaining weld seam. In an optical embodiment, the acute angle can be 45o. The present disclosure selects the manner of oblique targeting of the laser and direct targeting of the image acquisition device, which is very suitable for multi-layer multi-pass welding processing based on a laser image, and weld seam shapes and a proportional relationship can be acquired from the image.

In order to further ensure a good post-welding formation effect, in an optional solution, the first adjustment step includes: according to the second weld seam image, the remaining area to be filled of the ith weld layer is determined as a target area and the height of the welded weld pass of the ith weld layer is determined as a first target height; a second target height is determined as a maximum value among the first target heights, where the second target height is a welding height of the remaining weld passes of the ith weld layer; according to the target area and the second target height, the number of the weld passes remaining in the ith weld layer, welding paths of the remaining weld passes, and the welding operation parameters of the remaining weld passes are determined, so as to obtain target parameters; and corresponding parameters in the first welding strategy are modified as the target parameters, so as to obtain the second welding strategy. In the process, the remaining areas to be filled of the ith weld layer and the heights of the welded weld passes of the ith weld layer are first determined, and according to the determined areas to be filled and a maximum value among the heights, the number of the weld passes remaining in the ith weld layer, the welding paths of the remaining weld passes, and the welding operation parameters of the remaining weld passes are determined to adjusted the first welding strategy, so as to obtain the second welding strategy. Therefore, the effect of adjusting the welding strategy of the remaining weld passes according to the actual welding situations of the weld passes of the ith weld layer is achieved, and it ensures that in the same weld layer, the heights of the remaining weld passes are consistent with those of the welded weld passes, thereby further ensuring the good post-welding formation effect.

Specifically, the specific implementation process of according to the target area and the second target height, determining the number of the weld passes remaining in the ith weld layer, welding paths of the remaining weld passes, and the welding operation parameters of the remaining weld passes, so as to obtain the target parameters includes: according to the target area, the maximum deposition area for each weld, and the minimum deposition area, the number of the weld passes remaining in the ith weld layer is determined; according to the number of the weld passes remaining in the ith weld layer and the target area, a weld pass area of each remaining weld pass is determined; according to the weld pass area of each remaining weld pass and the second target height, a length of an upper bottom edge of each remaining weld pass and a length of an lower bottom edge of each remaining weld pass are determined; according to the a length of an upper bottom edge of each remaining weld pass and a length of an lower bottom edge of each remaining weld pass, a welding path of each remaining weld pass, including a welding start point coordinate and a welding end point coordinate, is determined; and according to the weld pass area of each remaining weld pass, the welding speed range of the welding device, and the wire feeding speed range, the welding operation parameters corresponding to each remaining weld pass are determined.

Further, the ith weld layer is a filling layer or capping layer of the weld seam. That is to say, the welding strategy of the weld passes in each filling layer needs to be adjusted through the second adjustment step, and the welding strategy of the weld passes in the capping layer of the weld seam also needs to be adjusted, ensuring that an upper surface of the obtained filling layer is basically horizontal, and ensuring that an upper surface of the obtained capping layer is basically horizontal, thereby realizing the consistent heights of the filling layer and the capping layer.

At S204, namely a second control step: according to the second welding strategy, the welding device is controlled to weld the current weld pass.

Optionally, the second control step includes: a first control sub-step: according to the second welding strategy, the welding device is controlled to weld the current weld pass, wherein the welded current weld pass is the previous weld pass; a determination sub-step: whether the previous weld pass is the last weld pass of the ith weld layer is determined; and a repetition sub-step: when the previous weld pass is not the last weld pass, the first adjustment step, the first control sub-step, and the determination sub-step are sequentially executed for at least once, until the previous weld pass is the last weld pass. Through the embodiments, the welding strategy before the welding of each weld pass of the ith weld layer is adjusted, thereby further ensuring a good welding effect of the ith weld layer.

Furthermore, the first welding strategy, the second welding strategy, and the initial welding strategy further respectively include determining a welding gun overlap point and a welding gun attitude angle. The welding gun overlap point for pass arrangement planning is used as an initial position, the position of the welding gun overlap point is accurately optimized in real time in the image, and a welding gun angle is corrected in real time to be on a bisector of an angle consisting of an overlap point and the top inflection point. The welding gun overlap point and the welding gun attitude angle in the image are converted in a welding gun three-dimensional coordinate system through a hand-eye calibration system, so as to implement a welding operation.

Through the embodiments, before welding the ith weld layer of the weld seam, according to the first weld seam image after the (i−1)th weld layer is welded, the first welding strategy of the ith weld layer, including the number of weld passes of the weld layer, the welding path of the weld pass, and the welding operation parameters, is determined; then, according to the first welding strategy, the welding device is controlled to weld at least one weld pass of the ith weld layer; then, according to the second weld seam image after the previous weld pass of the current weld pass is welded, the first welding strategy corresponding to the current weld pass of the ith weld layer is adjusted to obtain the second welding strategy; and finally, according to the second welding strategy, the welding device is controlled to weld the current weld pass. In the present disclosure, before one weld layer is welded, the corresponding first welding strategy is determined according to the welding image of the current weld seam, and the weld pass of the weld layer is welded based on the first welding strategy, ensuring that the first welding strategy relatively matches the weld layer of the current weld seam, thereby realizing real-time adjustment planning of the welding strategy for the weld layer. Moreover, before a weld pass of the current layer is welded, the first welding strategy is adjusted according to the weld seam images of the remaining weld passes of the current layer, so as to obtain the second welding strategy relatively matching the weld pass of the current layer, and the remaining weld passes of the current layer are continuously welded based on the second welding strategy, such that the real-time adjustment planning of the welding strategies corresponding to different weld passes of the same weld layer is realized, during multi-layer multi-pass welding, the layer-pass welding strategy is adjusted in real time according to actual welding situations, the real-time performance and accuracy of the layer-pass planning are ensured, difficult adaption of the welding layer-pass strategy planned in advance to thermal deformation, groove changes, and uneven height fluctuations of a welding member during welding is avoided, a good post-welding formation effect for multi-layer multi-pass welding is ensured, and the problem of a poor actual welding effect due to the inability of the one-time planning of a layer strategy for multi-layer multi-pass welding in the related art to adapt to subsequent weld changes is solved.

In order to enable those skilled in the art to understand the technical solutions of the present disclosure more clearly, the implementation process of the multi-layer multi-pass welding method of the present disclosure is described below in detail with reference to specific embodiments.

This embodiment involves a specific multi-layer multi-pass welding method, including the following steps.

At S1, an initial welding strategy is established according to weld seam size information of a weld seam before multi-layer multi-pass welding, and then S2 is executed.

At S2, according to the initial welding strategy, a 1st weld layer of the weld seam is welded, and then S3 is executed.

At S3, starting from the 2nd weld layer, a first weld layer currently to be welded of the remaining weld seam is used as a current weld layer; before the current weld layer of the weld seam is welded, a first welding strategy of the current weld layer is determined according to a first weld seam image; and according to the first welding strategy, a welding device is controlled to weld a 1st weld pass of the current weld layer, and then S4 is executed.

At S4, starting from the 2nd weld pass, a first one among the weld passes to be welded of the current weld layer is used as a current weld pass; before the current weld pass of the current weld layer is welded, according to a second weld seam image, the first welding strategy corresponding to the current weld pass of the current weld layer is adjusted to obtain a second welding strategy; and according to the second welding strategy, the welding device is controlled to weld the current weld pass of the current weld layer, and then S5 is executed.

At S5, whether the welded current weld pass is the last weld pass of the current weld layer is determined; if no, S4 is continuously executed; and if so, S3 is continuously executed, until the welding of the weld seam is completed.

It is to be noted that the steps shown in the flow diagram of the accompanying drawings can be executed in a computer system, such as a set of computer-executable instructions, and although a logical sequence is shown in the flow diagram, in some cases, the steps shown or described can be executed in a different order than here.

Embodiments of the present disclosure further provide a multi-layer multi-pass welding apparatus. It is to be noted that, the multi-layer multi-pass welding apparatus of the embodiments of the present disclosure can be configured to execute the multi-layer multi-pass welding method provided in the embodiments of the present disclosure. The apparatus is configured to implement the embodiments and the preferred implementations, and what has been described will not be described again. As used below, the term “module” can be a combination of software and/or hardware that implements a predetermined function. Although the apparatus described in the following embodiments is preferably implemented in software, but implementations in hardware, or a combination of software and hardware, are also possible and conceived.

The multi-layer multi-pass welding apparatus provided in the embodiments of the present disclosure is introduced below.

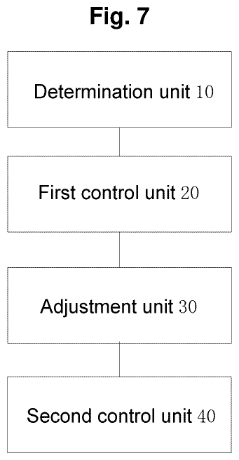

FIG. 7 is a schematic diagram of a multi-layer multi-pass welding apparatus according to embodiments of the present disclosure. As shown in FIG. 7, the apparatus includes a determination unit.

The determination unit 10 is configured to perform a first determination step: before welding an ith weld layer of a weld seam, according to a first weld seam image, a first welding strategy for the ith weld layer is determined, where the first weld seam image is a weld seam image after an (i−1)th weld layer is welded, and the first welding strategy includes the number of weld passes of a weld layer, a welding path of the weld pass, and welding operation parameters, with i≥2 and i being an integer.

Specifically, the welding operation parameters include a welding speed, a wire feeding speed, and a heat input amount. Definitely, in addition to the welding speed, the wire feeding speed, and the heat input amount, operation parameters such as a welding current, a welding voltage, and a welding gun swing can further be included, and the wire feeding speed is directly related to the welding current, the welding voltage, and the heat input amount. The welding path is a path including a welding start point coordinate and a welding end point coordinate.

In an optional embodiment, the determination unit specifically includes a first determination module.

The first determination module is configured to, according to the first weld seam image, determine angle information of grooves of remaining weld seam, an internal height of the remaining weld seam, the number of target weld passes, an area to be filled of each target weld pass, and a height of each target weld pass, where the remaining weld seam are the weld seams filled with the (i−1)th weld layer, the target weld pass is the weld pass in the ith weld layer, and the number of the target weld passes is the quantity of the target weld passes.

Specifically, the internal height of the remaining weld seam is a depth of the remaining weld seam, and does not include a weld reinforcement. In order to ensure a post-welding formation effect, the heights of all weld passes of each weld layer remain the same, that is to say, the height of each target weld pass is the same.

It is to be noted that, the first weld seam image is acquired when an image acquisition device of the welding device directly targets the remaining weld seam and a laser obliquely targets the remaining weld seam, that is, an optical axis of the image acquisition device is vertical to groove surfaces of the remaining weld seam, and a laser line of the laser is at an acute angle to the groove surfaces of the remaining weld seam. In an optical embodiment, the acute angle can be 45°. The present disclosure selects the manner of oblique targeting of the laser and direct targeting of the image acquisition device, which is very suitable for multi-layer multi-pass welding processing based on a laser image, and weld seam shapes and a proportional relationship can be acquired from the image.

Further, the first determination module includes: a first determination sub-module, configured to, according to the first weld seam image, determine the angle information comprising a left groove angle and a right groove angle, and the internal height of the remaining weld seam; a second determination sub-module, configured to, according to the internal height of the remaining weld seam and a weld reinforcement, determine welding heights of the remaining weld seam as a first height, and according to the first height, a maximum penetration depth for each weld, and a minimum penetration depth for each weld, determine the number of weld layers of the remaining weld seam; a third determination sub-module, configured to, according to the first height and the number of the weld layers of the remaining weld seam, determine a welding height of the ith weld layer as the height of each target weld pass, and according to the height of the target weld pass, the left groove angle, and the right groove angle, determine an area to be filled of the ith weld layer; and a fourth determination sub-module, configured to, according to the area to be filled of the ith weld layer, a maximum deposition area for each weld, and a minimum deposition area, determine the number of the target weld passes and the area to be filled of each target weld pass.

The left groove angle is an included angle between a groove surface of a left groove and a vertical direction; the right groove angle is an included angle between a groove surface of a right groove and the vertical direction; the first height is a sum of the internal height of the remaining weld seam and the weld reinforcement; and the maximum penetration depth for each weld and the minimum penetration depth can be predetermined according to parameters of the welding device itself.

During actual application, according to the first weld seam image, determining the angle information including the left groove angle and the right groove angle, and the internal height of the remaining weld seam can be implemented as follows: centerline extraction is performed on the first weld seam image to obtain a laser centerline, coordinates of two bottom inflection points in the image, and coordinates of two top inflection points in the image; according to the laser centerline, the coordinates of the two bottom inflection points in the image, and the coordinates of the two top inflection points in the image, the left groove angle, the right groove angle, a spacing between the two top inflection points in the image, and the area to be filled of the remaining weld seam in the image are determined; according to the left groove angle, the right groove angle, the spacing between the two top inflection points in the image, and the area to be filled of the remaining weld seam in the image, a numerical value of the internal height of the remaining weld seam in the image is determined; and coordinate system conversion is performed on the numerical value to obtain the internal height of the remaining weld seam, where the coordinate system conversion includes converting an image coordinate system into a camera coordinate system, and then converting the camera coordinate system into world coordinates.

The above phrase “according to the laser centerline” refer to according to the position of the laser centerline and the shape of the laser centerline.

In an exemplary embodiment, since an interface of the remaining weld seam in a width direction of the weld seam can be equivalent to a trapezoid, according to the left groove angle, the right groove angle, the spacing between the two top inflection points in the image, and the area to be filled of the remaining weld seam in the image, the numerical value of the internal height in the image is determined, which is actually a process of calculating the height of the trapezoid. The height can be calculated through deformation using an area formula of the trapezoid: area=½×(upper bottom edge of trapezoid+lower bottom edge of trapezoid)×height. The upper bottom edge of the trapezoid and the lower bottom edge of the trapezoid are obtained by performing trigonometric function calculation on the left groove angle, the right groove angle, and the spacing between the two top inflection points in the image.

Furthermore, according to the first height, the maximum penetration depth for each weld, and the minimum penetration depth, determining the number of the weld layers of the remaining weld seam can specifically be implemented as follows: a value range of the number of the weld layers is determined according to the first height, the maximum penetration depth, and the minimum penetration depth, and then an integer value is determined from the value range as the number of the weld layers. In order to simplify calculation, based on the equal height principle of each weld layer, and according to the first height and the number of the weld layers of the remaining weld seam, the welding height of the ith weld layer is determined as the height of each target weld pass, which is actually a process of, according to the first height and the number of the weld layers of the remaining weld seam, determining an average welding height of each weld layer. Since a cross section of each weld layer in the width direction of the weld seam can also be equivalent to the trapezoid, determining the area to be filled of the ith weld layer according to the height of the target weld pass, the left groove angle, and the right groove angle is actually a process of calculating an area of the trapezoid. According to the area to be filled of the ith weld layer, the maximum deposition area for each weld, and the minimum deposition area, determining the number of the target weld passes and the area to be filled of each target weld pass can be implemented as follows: according to the area to be filled of the ith weld layer, the maximum deposition area for each weld, and the minimum deposition area, a value range of the number of the target weld passes is determined; then an integer value is determined as the number of the target weld passes from the value range of the number of the target weld passes; and based on an equal area principle of each target weld pass, and according to the area to be filled of the ith weld layer, and the number of the target weld passes, the area to be filled of each target weld pass is determined.

Definitely, the manner of, according to the first weld seam image, determining the angle information of the grooves of the remaining weld seam, the internal height of the remaining weld seam, the number of the target weld passes, the area to be filled of each target weld pass, and the height of each target weld pass is not limited to an enumerative manner. Those skilled in the art can flexibly select an appropriate manner to calculate the angle information of the grooves of the remaining weld seam, the internal height of the remaining weld seam, the number of the target weld passes, the area to be filled of each target weld pass, and the height of each target weld pass based on size and position information extracted from the first weld seam image according to actual situations.

An establishment module is configured to use a target inflection point as a coordinate origin point to establish a coordinate system shown in FIG. 4, and according to an initial internal height, a root gap of the weld seam, the angle information, the internal height of the remaining weld seam, the number of the target weld passes, the area to be filled of the target weld pass, and the height of the target weld pass, determine the welding path of each of the target weld passes, including a welding start point coordinate and a welding end point coordinate, where the target inflection point is one of two groove inflection points of the weld seam, and the initial internal height is the internal height of the weld seam before multi-layer multi-pass welding.

Specifically, the groove inflection point is a top inflection point of the groove.

FIG. 4 shows that a coordinate position of each weld pass, as well as a boundary point of each layer and each pass, bottom overlap points and the like, are determined by using a left-side top inflection point of the groove as an original point, using an x-axis direction as a direction from the left-side top inflection point to a right-side top inflection point, and using a y-axis direction as a direction (a direction perpendicular to the groove) in which the left-side top inflection point points toward the bottom of the groove.

Further, as shown in FIG. 5, in the first welding strategy, the last target weld pass of the ith weld layer is a trapezoidal weld pass, and the target weld passes other than the last target weld pass are parallelogram weld passes. The establishment module includes as follows.

A fifth determination sub-module is configured to, according to the area to be filled of the target weld pass and the height of the target weld pass, determine a bottom edge length of each parallelogram weld pass to be dᵢ=S′ᵢ/hₖᵢ, where di is the bottom edge length of each parallelogram weld pass, S′ᵢ is the area to be filled of the target weld pass, and hₖᵢ is the height of the target weld pass.

A sixth determination sub-module is configured to, according to the bottom edge length of each parallelogram weld pass, the initial internal height, the root gap, the angle information, the internal height of the remaining weld seam, and the number of the target weld passes, determine a lower edge length of the trapezoidal weld pass to be d_{ib}=g+(tan α+tan β)×(H−hₖ)−(nᵢ−1)×dᵢ, where d_{ib} is the lower edge length, α is a left groove angle, β is a right groove angle, the left groove angle and the right groove angle constitute the angle information, H is the initial internal height, hₖ is the internal height of the remaining weld seam, and nᵢ is the number of the target weld passes.

A seventh determination sub-module is configured to, according to the bottom edge length of each parallelogram weld pass, the initial internal height, the root gap, the angle information, the internal height of the remaining weld seam, the height of the target weld pass, and the number of the target weld passes, determine an upper edge length of the trapezoidal weld pass to be dᵢₜ=g+(tan α+tan β)×(H−hₖ+hₖᵢ)−(nᵢ−1)×dᵢ, where dᵢₜ is the upper edge length, and hₖᵢ is the height of the target weld pass.

An eighth determination sub-module is configured to, according to each bottom edge length, the upper edge length, and the lower edge length, determine the welding start point coordinate and the welding end point coordinate corresponding to each target weld pass.

In the embodiments, the welding start point coordinate and the welding end point coordinate of each weld pass are converted into upper and lower bottom edge lengths of each target weld pass through calculation, and then in the established coordinate system, the welding start point coordinate and the welding end point coordinate of each target weld pass are determined according to the upper and lower bottom edge lengths and the height, such that it ensures that a weld pass planning strategy suitable for the current weld layer can be obtained simply and accurately, the real-time performance and high accuracy of weld pass planning are further ensured, and an impact of welding changes on weld seam parameters is fully taken into consideration.

It is to be noted that, the last target weld pass of the ith weld layer being the trapezoidal weld pass means that the target weld pass is cut open in the width direction of the weld seam, a cross-sectional shape of the target weld pass is approximately a trapezoid, and the width direction is a direction connecting two top inflection points. The target weld passes other than the last target weld pass being parallelogram weld passes means that the target weld pass is cut open in the width direction of the weld seam, and the cross-sectional shape of the target weld pass is approximately a parallelogram.

A second determination module is configured to, according to the area to be filled of the target weld pass, a welding speed range of the welding device, and a wire feeding speed range, determine the welding operation parameters of each of the target weld passes, so as to obtain the first welding strategy.

In the specific implementation process of the first determination step, first, according to the first weld seam image, the angle information of the grooves of the remaining weld seam, the internal height of the remaining weld seam, and the ith weld layer are determined, that is, information such as the number of the weld passes of the current weld layer, the area to be filled of each weld pass, the height, etc.; then, one of the two groove inflection points is used as the coordinate origin point to establish the coordinate system, and based on the coordinate system, and according to the information determined from the first weld seam image and the internal height and root gap of the entire weld seam before welding, the welding path of each weld pass, including the welding start point coordinate and the welding end point coordinate, is determined; and finally, according to the area to be filled of the target weld pass, the welding speed range, and the wire feeding speed range, the welding operation parameters including the welding speed and the wire feeding speed are determined, so as to obtain the first welding strategy. Compared to the use of a bottom center of an original groove of a workpiece as a coordinate origin point, in an actual welding process of multi-layer multi-pass welding, with the proceeding of welding and filling, bottom information of the groove changes at any time, and the bottom center is present only when the first one among the weld passes of the weld seam is filled, causing the origin point to disappear during subsequent welding, thus leading to instability in multi-layer multi-pass models and strategies. In the present disclosure, the coordinate system is established by using the top inflection point as the coordinate origin point, and the path of each pass of each layer in the coordinate system is determined, such that the first welding strategy is updated in real time according to welding situations, thereby further realizing real-time adjustment of the layer-pass welding strategy for multi-layer multi-pass welding according to actual welding situations. Therefore, the real-time performance and accuracy of layer-pass planning are further ensured, and difficult adaption of the welding layer-pass strategy planned in advance to thermal deformation, groove changes, and uneven height fluctuations of a welding member during welding is further avoided.

In order to further realize the matching of the welding operation parameters of the welding device with the layer-pass welding strategy currently determined, in an optional solution, the second determination module can specifically include: a ninth determination sub-module, configured to perform a second determination step: a welding speed within the welding speed range is determined, and a wire feeding speed is determined according to the area to be filled of the target weld passes, the welding speed, and a formula

$${S}_{i} = \frac{π {D}^{2} Fa}{4 V} ,$$

where Sᵢ is the area to be filled of the target weld pass, V is the welding speed, F is the wire feeding speed, D is a welding wire diameter, and a is a preset deposition coefficient; an adjustment sub-module, configured to perform a second adjustment step: when the wire feeding speed is not within the wire feeding speed range, the wire feeding speed is adjusted to the wire feeding speed range, so as to obtain the adjusted wire feeding speed, and according to the adjusted wire feeding speed, the area to be filled of the target weld pass, and the formula

$${S}_{i} = \frac{π {D}^{2} Fa}{4 V} ,$$

the welding speed is adjusted to obtain the adjusted welding speed; and a repetition sub-module, configured to perform a repetition step: when the adjusted welding speed is not within the welding speed range, the second determination step and the second adjustment step are sequentially executed for at least once, until the adjusted wire feeding speed is within the wire feeding speed range, and the adjusted welding speed is within the welding speed range.

In the embodiments of the present disclosure, the welding speed is fixed first to adjust the wire feeding speed, such that the adjusted wire feeding speed meets the wire feeding speed range, so as to ensure that a requirement for the heat input amount is met. When the wire feeding speed is adjusted, if the wire feeding speed exceeds the wire feeding speed range, causing the heat input amount to not meet the heat input amount range, the wire feeding speed meeting the heat input amount is then fixed to adjust the welding speed, until the welding speed and the wire feeding speed both meet the corresponding ranges, and the welding heat input amount meets the requirement through the repetition and adjustment processes, such that it further ensures that the welding operation parameters match the welding strategy of the current layer, thereby further ensuring a good welding effect.

The welding operation parameters of each weld pass need to be determined in a manner. Since the heat input amount meeting welding quality is a range and the wire feeding speed is directly related to the welding current, the welding voltage, and the heat input amount, through analysis of a large number of process parameters, the most stable and common welding speed is acquired as a fixed value, so as to adjust the wire feeding speed.

According to still another specific embodiment of the present disclosure, the apparatus further includes: an establishment unit, configured to, before the first determination step, establish an initial welding strategy according to weld seam size information of the weld seam before multi-layer multi-pass welding, where the initial welding strategy includes the number of weld layers of the weld seam, the number of weld passes of the weld seam, the welding path of each weld pass of the weld seam, and the welding operation parameters of each weld pass of the weld seam. The determination unit includes: an adjustment module, configured to, before welding the ith weld layer of the weld seam, adjust the initial welding strategy according to the first weld seam image, so as to obtain the first welding strategy. That is to say, in the present disclosure, before the weld seam is welded, the initial welding strategy is established according to an actual assembly situation of a workpiece, and the weld seam is welded based on the initial welding strategy; during welding, thermal deformation is taken into consideration, and shape features of the remaining weld seam are acquired in real time; and the initial welding strategy is adjusted according to the shape feature information, so as to obtain the first welding strategy matching a current shape feature. Therefore, it avoids the welding of the entire weld seam according to the initial welding strategy, resulting in excessive weld passes and weld seam stacking, thus making it difficult to match an actual welding trajectory with a planned start and end point coordinates, increasing cumulative errors, and making it difficult to ensure the welding quality.

A first control unit 20 is configured to perform a first control step: according to the first welding strategy, controlling a welding device to weld at least one weld pass of the ith weld layer.

Specifically, according to the first welding strategy, only the last weld pass of the ith weld layer can be welded, or a plurality of weld passes of the ith weld layer can also be continuously welded in sequence according to the first welding strategy.

In another exemplary solution, the first control unit includes: a first control module, configured to control the welding device to operate according to the welding operation parameters, and to weld the 1st weld pass of the ith weld layer along the welding path from the welding start point coordinate.

An adjustment unit 30 is configured to perform a first adjustment step: according to a second weld seam image as shown in FIG. 6, the first welding strategy corresponding to a current weld pass of the ith weld layer is adjusted, so as to obtain a second welding strategy, where the current weld pass is the weld pass to be welded, and the second weld seam image is a weld seam image after a previous weld pass of the current weld pass is welded.

Specifically, the second welding strategy also includes the number of weld passes of the weld layer, the welding path of the weld pass, and the welding operation parameters. The current weld pass is a jth weld pass of the ith weld layer; and the previous weld pass can be the 1st weld pass of the ith weld layer, or can also be a (j−1)th of the ith weld layer.

It is to be noted that, the second weld seam image is also acquired when an image acquisition device of the welding device directly targets the remaining weld seam and a laser obliquely targets the remaining weld seam, that is, an optical axis of the image acquisition device is vertical to groove surfaces of the remaining weld seam, and a laser line of the laser is at an acute angle to the groove surfaces of the remaining weld seam. In an optical embodiment, the acute angle can be 45°. The present disclosure selects the manner of oblique targeting of the laser and direct targeting of the image acquisition device, which is very suitable for multi-layer multi-pass welding processing based on a laser image, and weld seam shapes and a proportional relationship can be acquired from the image.

In order to further ensure a good post-welding formation effect, in an optional solution, the adjustment unit includes: a third determination module, configured to, according to the second weld seam image, determine the remaining area to be filled of the ith weld layer as a target area and the height of the welded weld pass of the ith weld layer as a first target height; a fourth determination module, configured to determine a second target height as a maximum value among the first target heights, where the second target height is a welding height of the remaining weld passes of the ith weld layer; a fifth determination module, configured to, according to the target area and the second target height, determine the number of the weld passes remaining in the ith weld layer, welding paths of the remaining weld passes, and the welding operation parameters of the remaining weld passes, so as to obtain target parameters; and a modification module, configured to modify corresponding parameters in the first welding strategy as the target parameters, so as to obtain the second welding strategy. In the process, the remaining areas to be filled of the ith weld layer and the heights of the welded weld passes of the ith weld layer are first determined, and according to the determined areas to be filled and a maximum value among the heights, the number of the weld passes remaining in the ith weld layer, the welding paths of the remaining weld passes, and the welding operation parameters of the remaining weld passes are determined to adjusted the first welding strategy, so as to obtain the second welding strategy. Therefore, the effect of adjusting the welding strategy of the remaining weld passes according to the actual welding situations of the weld passes of the ith weld layer is achieved, and it ensures that in the same weld layer, the heights of the remaining weld passes are consistent with those of the welded weld passes, thereby further ensuring the good post-welding formation effect.

Specifically, the fifth determination module includes: a tenth determination sub-module, configured to, according to the target area, the maximum deposition area for each weld, and the minimum deposition area, determine the number of the weld passes remaining in the ith weld layer; an eleventh determination sub-module, configured to, according to the number of the weld passes remaining in the ith weld layer and the target area, determine a weld pass area of each remaining weld pass; a twelfth determination sub-module, configured to, according to the weld pass area of each remaining weld pass and the second target height, determine a length of an upper bottom edge of each remaining weld pass and a length of an lower bottom edge of each remaining weld pass; a thirteenth determination sub-module, configured to, according to the a length of an upper bottom edge of each remaining weld pass and a length of an lower bottom edge of each remaining weld pass, determine a welding path of each remaining weld pass, comprising a welding start point coordinate and a welding end point coordinate; and a fourteenth determination sub-module, configured to, according to the weld pass area of each remaining weld pass, the welding speed range of the welding device, and the wire feeding speed range, determine the welding operation parameters corresponding to each remaining weld pass.

Further, the ith weld layer is a filling layer or capping layer of the weld seam. That is to say, the welding strategy of the weld passes in each filling layer needs to be adjusted through the second adjustment step, and the welding strategy of the weld passes in the capping layer of the weld seam also needs to be adjusted, ensuring that an upper surface of the obtained filling layer is basically horizontal, and ensuring that an upper surface of the obtained capping layer is basically horizontal, thereby realizing the consistent heights of the filling layer and the capping layer.

A second control unit 40 is configured to perform a second control step: according to the second welding strategy, the welding device is controlled to weld the current weld pass.

Optionally, the second control unit includes: a second control module, configured to perform a first control sub-step: according to the second welding strategy, the welding device is controlled to weld the current weld pass, where the welded current weld pass is the previous weld pass; a sixth determination module, configured to perform a determination sub-step: whether the previous weld pass is the last weld pass of the ith weld layer is determined; and a repetition module, configured to perform a repetition sub-step: when the previous weld pass is not the last weld pass, the first adjustment step, the first control sub-step, and the determination sub-step are sequentially executed for at least once, until the previous weld pass is the last weld pass. Through the embodiments, the welding strategy before the welding of each weld pass of the ith weld layer is adjusted, thereby further ensuring a good welding effect of the ith weld layer.

Furthermore, the first welding strategy, the second welding strategy, and the initial welding strategy further respectively include determining a welding gun overlap point and a welding gun attitude angle. The welding gun overlap point for pass arrangement planning is used as an initial position, the position of the welding gun overlap point is accurately optimized in real time in the image, and a welding gun angle is corrected in real time to be on a bisector of an angle consisting of an overlap point and the top inflection point. The welding gun overlap point and the welding gun attitude angle in the image are converted in a welding gun three-dimensional coordinate system through a hand-eye calibration system, so as to implement a welding operation.

Through the embodiments, before welding the ith weld layer of the weld seam, the first welding strategy of the ith weld layer, including the number of weld passes of the weld layer, the welding path of the weld pass, and the welding operation parameters, is determined by the determination unit according to the first weld seam image after the (i−1)th weld layer is welded; the welding device is controlled by the first control unit to weld at least one weld pass of the ith weld layer according to the first welding strategy; the first welding strategy corresponding to the current weld pass of the ith weld layer is adjusted by the adjustment unit according to the second weld seam image after the previous weld pass of the current weld pass is welded, so as to obtain the second welding strategy; and the welding device is controlled by the second control unit to weld the current weld pass according to the second welding strategy. In the present disclosure, before one weld layer is welded, the corresponding first welding strategy is determined according to the welding image of the current weld seam, and the weld pass of the weld layer is welded based on the first welding strategy, ensuring that the first welding strategy relatively matches the weld layer of the current weld seam, thereby realizing real-time adjustment planning of the welding strategy for the weld layer. Moreover, before a weld pass of the current layer is welded, the first welding strategy is adjusted according to the weld seam images of the remaining weld passes of the current layer, so as to obtain the second welding strategy relatively matching the weld pass of the current layer, and the remaining weld passes of the current layer are continuously welded based on the second welding strategy, such that the real-time adjustment planning of the welding strategies corresponding to different weld passes of the same weld layer is realized, during multi-layer multi-pass welding, the layer-pass welding strategy is adjusted in real time according to actual welding situations, the real-time performance and accuracy of the layer-pass planning are ensured, difficult adaption of the welding layer-pass strategy planned in advance to thermal deformation, groove changes, and uneven height fluctuations of a welding member during welding is avoided, a good post-welding formation effect for multi-layer multi-pass welding is ensured, and the problem of a poor actual welding effect due to the inability of the one-time planning of a layer strategy for multi-layer multi-pass welding in the related art to adapt to subsequent weld changes is solved.

The multi-layer multi-pass welding apparatus includes a processor and a memory. The determination unit, the first control unit, the adjustment unit, the second control unit, and the like are all stored in the memory as program units. The processor executes the program units stored in the memory to implement corresponding functions. The modules are all located in the same processor; or the modules are located in different processors in any combination.

The processor includes a kernel, and the kernel invokes the corresponding program units from the memory. There can be one or more kernels arranged. The problem of a poor actual welding effect due to the inability of the one-time planning of a layer strategy for multi-layer multi-pass welding in the related art to adapt to subsequent weld changes is at least solved by adjusting kernel parameters.

The memory can include a non-persistent memory in a computer-readable medium, a Random Access Memory (RAM) and/or a non-volatile memory, for example, a Read Only Memory (ROM) or a flash memory (flash RAM). The memory includes at least one memory chip.

Embodiments of the present disclosure provide a computer-readable storage medium. The computer-readable storage medium includes a stored program. When the program is operated, a device where the computer-readable storage medium is located is controlled to execute the multi-layer multi-pass welding method.

Embodiments of the present disclosure provide a processor. The processor is configured to operate a program. The multi-layer multi-pass welding method is executed when the program is operated.

Embodiments of the present disclosure provide an electric device. The electric device includes a processor, a memory, and a program stored on the memory and executable on the processor. The processor, when executing the program, implements at least the following steps.

At S201, namely a first determination step: before welding an ith weld layer of a weld seam, according to a first weld seam image, a first welding strategy for the ith weld layer is determined, where the first weld seam image is a weld seam image after an (i−1)th weld layer is welded, and the first welding strategy includes the number of weld passes of a weld layer, a welding path of the weld pass, and welding operation parameters, with i≥2 and i being an integer.

At S202, namely a first control step: according to the first welding strategy, a welding device is controlled to weld at least one weld pass of the ith weld layer.

At S203, namely a first adjustment step: according to a second weld seam image, the first welding strategy corresponding to a current weld pass of the ith weld layer is adjusted, so as to obtain a second welding strategy, where the current weld pass is the weld pass to be welded, and the second weld seam image is a weld seam image after a previous weld pass of the current weld pass is welded.

At S204, namely a second control step: according to the second welding strategy, the welding device is controlled to weld the current weld pass.

The device herein can be a server, a PC, a PAD, a mobile phone, or the like.

The present disclosure further provides a computer program product. When being executed on a data processing device, the computer program product is adapted to execute a program initialized with at least the following method steps.

At S201, namely a first determination step: before welding an ith weld layer of a weld seam, according to a first weld seam image, a first welding strategy for the ith weld layer is determined, where the first weld seam image is a weld seam image after an (i−1)th weld layer is welded, and the first welding strategy includes the number of weld passes of a weld layer, a welding path of the weld pass, and welding operation parameters, with i≥2 and i being an integer.

At S202, namely a first control step: according to the first welding strategy, a welding device is controlled to weld at least one weld pass of the ith weld layer.

At S203, namely a first adjustment step: according to a second weld seam image, the first welding strategy corresponding to a current weld pass of the ith weld layer is adjusted, so as to obtain a second welding strategy, where the current weld pass is the weld pass to be welded, and the second weld seam image is a weld seam image after a previous weld pass of the current weld pass is welded.

At S204, namely a second control step: according to the second welding strategy, the welding device is controlled to weld the current weld pass.

Another typical embodiment of the present disclosure further provides a welding system, including: a welding device; and a controller of the welding device. The controller is communicatively connected or electrically connected to the welding device, and includes one or more processors, a memory, and one or more programs, where the one or more programs are stored in the memory, and are configured to be executed by the one or more processors; and the one or more programs include instructions for executing any one of the methods.

The welding system includes the welding device and the controller. The controller is configured to execute any one of the multi-layer multi-pass welding methods. Before a weld layer is welded in the method, the corresponding first welding strategy is determined according to the welding image of the current weld seam, and the weld pass of the weld layer is welded based on the first welding strategy, ensuring that the first welding strategy relatively matches the weld layer of the current weld seam, thereby realizing real-time adjustment planning of the welding strategy for the weld layer. Moreover, before a weld pass of the current layer is welded, the first welding strategy is adjusted according to the weld seam images of the remaining weld passes of the current layer, so as to obtain the second welding strategy relatively matching the weld pass of the current layer, and the remaining weld passes of the current layer are continuously welded based on the second welding strategy, such that the real-time adjustment planning of the welding strategies corresponding to different weld passes of the same weld layer is realized, during multi-layer multi-pass welding, the layer-pass welding strategy is adjusted in real time according to actual welding situations, the real-time performance and accuracy of the layer-pass planning are ensured, difficult adaption of the welding layer-pass strategy planned in advance to thermal deformation, groove changes, and uneven height fluctuations of a welding member during welding is avoided, a good post-welding formation effect for multi-layer multi-pass welding is ensured, and the problem of a poor actual welding effect due to the inability of the one-time planning of a layer strategy for multi-layer multi-pass welding in the related art to adapt to subsequent weld changes is solved.

It is to be noted that, the welding device can be communicatively or electrically connected to the controller of the welding device.

It is apparent that those skilled in the art should understand that the modules or steps of the present disclosure can be implemented by a general computing device, and can also be gathered together on a single computing device or distributed in network composed of multiple computing devices. The above mentioned modules or steps of the present disclosure can be implemented with program codes executable by the computing device, so that can be stored in a storage device for execution by the computing device, and in some cases, the steps shown or described can be performed in a different sequence than herein, or can be fabricated into individual integrated circuit modules respectively, or multiple modules or steps thereof are fabricated into a single integrated circuit module for implementation. In this way, the present disclosure is not limited to any specific combination of hardware and software.

Those skilled in the art should understand that the embodiments of the present disclosure can be provided as a method, a system, or a computer program product. Therefore, the present disclosure can adopt forms of complete hardware embodiments, complete software embodiments or embodiments integrating software and hardware. Moreover, the present disclosure can adopt the form of a computer program product implemented on one or more computer available storage media (including but being not limited to a disk memory, a Compact Disc Read Only Memory (CD-ROM), an optical memory, and the like) containing computer available program codes.

The present disclosure is described with reference to flowcharts and/or block diagrams of the method, the device (system) and the computer program product according to the embodiments of the present disclosure. It should be understood that each flow and/or block in the flowchart and/or block diagram, and the combination of the flow and/or block in the flowchart and/or block diagram can be implemented by the computer program instructions. These computer program instructions can be provided to a processor of a general-purpose computer, a special-purpose computer, an embedded processor or other programmable data processing devices to generate a machine, so that instructions which are executed by the processor of the computer or other programmable data processing devices generate a device which is used for implementing the specified functions in one or more flows of the flowchart and/or one or more blocks of the block diagram.

These computer program instructions can also be stored in the computer-readable memory which can guide the computer or other programmable data processing devices to work in a particular way, so that the instructions stored in the computer-readable memory generate a product including an instruction device. The instruction device implements the specified functions in one or more flows of the flowchart and/or one or more blocks of the block diagram.

These computer program instructions can also be loaded on the computer or other programmable data processing devices, so that a series of operation steps are performed on the computer or other programmable data processing devices to generate the processing implemented by the computer, and the instructions executed on the computer or other programmable data processing devices provide the steps for implementing the specified functions in one or more flows of the flowchart and/or one or more blocks of the block diagram.

In a typical configuration, a computing device includes one or more processors (CPUs), an input/output interface, a network interface, and an internal memory.

The memory can include a non-persistent memory in a computer-readable medium, a Random Access Memory (RAM) and/or a non-volatile memory, for example, a Read Only Memory (ROM) or a flash memory (flash RAM). The memory is an example of the computer-readable medium.

The computer-readable medium includes both persistent and non-permanent, removable and non-removable media, and can achieve information storage by any method or technology. The information can be a computer-readable instruction, a data structure, a module of a program, or other data. Examples of a computer storage medium include but are not limited to a Phase Change Memory (PRAM), a Static Random Access Memory (SRAM), a Dynamic Random Access Memory (DRAM), other types of Random Access Memories (RAM), a Read-Only Memory (ROM), an Electrically Erasable Programmable Read-Only Memory (EEPROM), a flash memory or other memory technologies, a Compact Disk Read-Only Memory (CD-ROM), a Digital Versatile Disc (DVD) or other optical storages, a cartridge storage, a magnetic tape disk storage or other magnetic storage devices or any other non-transmitting medium that can be configured to store information accessible by a computing device. According to the definition herein, the computer-readable medium does not include transitory computer-readable media, such as modulated data signals and carriers.

It is also to be noted that, terms “comprise”, “include” or any other variants are intended to encompass non-exclusive inclusion, such that a process, a method, a commodity, or a device including a series of elements not only include those elements, but also includes other elements not listed explicitly or includes intrinsic elements for the process, the method, the commodity, or the device. Without any further limitation, an element defined by the phrase “comprising one” does not exclude existence of other same elements in the process, the method, the commodity, or the device that includes the elements.

The above are only the preferred embodiments of the present disclosure and are not intended to limit the present disclosure. For those skilled in the art, the present disclosure can have various modifications and variations. Any modifications, equivalent replacements, improvements and the like made within the spirit and principle of the present disclosure shall fall within the scope of protection of the present disclosure.

1. A multi-layer multi-pass welding method, comprising:
a first determination step: before welding an ith weld layer of a weld seam, according to a first weld seam image, determining a first welding strategy for the ith weld layer and controlling a display device to display a number of weld passes of a weld layer in the first welding strategy, wherein the first weld seam image is a weld seam image after an (i−1)th weld layer is welded, and the first welding strategy further comprises a welding path of the weld pass and welding operation parameters, with i≥2 and i being an integer;
a first control step: according to the first welding strategy, controlling a welding device to weld at least one weld pass of the ith weld layer;
a first adjustment step: according to a second weld seam image, adjusting the first welding strategy corresponding to a current weld pass of the ith weld layer, so as to obtain a second welding strategy, wherein the current weld pass is a weld pass to be welded, and the second weld seam image is a weld seam image after a previous weld pass of the current weld pass is welded; and
a second control step: according to the second welding strategy, controlling the welding device to weld the current weld pass.

2. The method according to claim 1, wherein the first determination step comprises:
according to the first weld seam image, determining angle information of grooves of remaining weld seam, an internal height of the remaining weld seam, a number of target weld passes, an area to be filled of each target weld pass, and a height of each target weld pass, wherein the remaining weld seam are a weld seam filled with the (i−1)th weld layer, the target weld pass is the weld pass in the ith weld layer, and the number of the target weld passes is a quantity of the target weld passes;
using a target inflection point as a coordinate origin point to establish a coordinate system, and according to an initial internal height, a root gap of the weld seam, the angle information, the internal height of the remaining weld seam, the number of the target weld passes, the area to be filled of the target weld pass, and the height of the target weld pass, determining the welding path of each of the target weld passes, comprising a welding start point coordinate and a welding end point coordinate, wherein the target inflection point is one of two groove inflection points of the weld seam, and the initial internal height is an internal height of the weld seam before multi-layer multi-pass welding; and
according to the area to be filled of the target weld pass, a welding speed range of the welding device, and a wire feeding speed range, determining the welding operation parameters of each of the target weld passes, so as to obtain the first welding strategy.

3. The method according to claim 2, wherein according to the first weld seam image, determining the angle information of the grooves of the remaining weld seam, the internal height of the remaining weld seam, the number of the target weld passes, the area to be filled of each target weld pass, and the height of each target weld pass comprises:
according to the first weld seam image, determining the angle information comprising a left groove angle and a right groove angle, and the internal height of the remaining weld seam;
according to the internal height of the remaining weld seam and a weld reinforcement, determining a welding height of the remaining weld seam as a, first height and according to the first height, a maximum penetration depth for each weld, and a minimum penetration depth for each weld, determining a number of weld layers of the remaining weld seam;
according to the first height and the number of the weld layers of the remaining weld seam, determining a welding height of the ith weld layer as the height of each target weld pass, and according to the height of the target weld pass, the left groove angle, and the right groove angle, determining an area to be filled of the ith weld layer; and
according to the area to be filled of the ith weld layer, a maximum deposition area for each weld, and a minimum deposition area, determining the number of the target weld passes and the area to be filled of each target weld pass.

4. The method according to claim 2, wherein in the first welding strategy, a last target weld pass of the ith weld layer is a trapezoidal weld pass, and the target weld passes other than the last target weld pass are parallelogram weld passes;
according to the initial internal height, the root gap of the weld seam, the angle information, the internal height of the remaining weld seam, the number of the target weld passes, the area to be filled of the target weld pass, and the height of the target weld pass, determining the welding path of each of the target weld passes, comprising the welding start point coordinate and the welding end point coordinate, comprises:
according to the area to be filled of the target weld pass and the height of the target weld pass, determining a bottom edge length of each parallelogram weld pass to be di=S′i/hki, wherein di is the bottom edge length of each parallelogram weld pass, S′i is the area to be filled of the target weld pass, and hki is the height of the target weld pass;
according to the bottom edge length of each parallelogram weld pass, the initial internal height, the root gap, the angle information, the internal height of the remaining weld seam, and the number of the target weld passes, determining a lower edge length of the trapezoidal weld pass to be dib=g+(tan α+tan β)×(H−hk)−(ni−1)×di, wherein dib is the lower edge length, α is a left groove angle, β is a right groove angle, the left groove angle and the right groove angle constitute the angle information, H is the initial internal height, hk is the internal height of the remaining weld seam, and ni is the number of the target weld passes;
according to the bottom edge length of each parallelogram weld pass, the initial internal height, the root gap, the angle information, the internal height of the remaining weld seam, the height of the target weld pass, and the number of the target weld passes, determining an upper edge length of the trapezoidal weld pass to be dit=g+(tan α+tan β)×(H−hk+hki)−(ni−1)×di, wherein dit is the upper edge length, and hki is the height of the target weld pass; and
according to each bottom edge length of each parallelogram weld pass, the upper edge length, and the lower edge length, determining the welding start point coordinate and the welding end point coordinate corresponding to each target weld pass.

5. The method according to claim 2, wherein according to the area to be filled of the target weld passes, the welding speed range of the welding device, and the wire feeding speed range, determining the welding operation parameters of each of the target weld passes comprises:
a second determination step: determining a welding speed within the welding speed range, and determining a wire feeding speed according to the area to be filled of the target weld passes, the welding speed, and a formula
$${S}_{i} = \frac{π {D}^{2} Fa}{4 V} ,$$
wherein Si is the area to be filled of the target weld pass, V is the welding speed, F is the wire feeding speed, D is a welding wire diameter, and a is a preset deposition coefficient;
a second adjustment step: when the wire feeding speed is not within the wire feeding speed range, adjusting the wire feeding speed to the wire feeding speed range, so as to obtain an adjusted wire feeding speed, and according to the adjusted wire feeding speed, the area to be filled of the target weld pass, and the formula
$${S}_{i} = \frac{π {D}^{2} Fa}{4 V} ,$$
adjusting the welding speed to obtain an adjusted welding speed; and
a repetition step: when the adjusted welding speed is not within the welding speed range, sequentially executing the second determination step and the second adjustment step for at least once, until the adjusted wire feeding speed is within the wire feeding speed range, and the adjusted welding speed is within the welding speed range.

6. The method according to claim 1, wherein, the second control step comprises:
a first control sub-step: according to the second welding strategy, controlling the welding device to weld the current weld pass, wherein the welded current weld pass is the previous weld pass;
a determination sub-step: determining whether the previous weld pass is a last weld pass of the ith weld layer; and
a repetition sub-step: when the previous weld pass is not the last weld pass, sequentially executing the first adjustment step, the first control sub-step, and the determination sub-step for at least once, until the previous weld pass is the last weld pass.

7. The method according to claim 1, wherein, the first adjustment step comprises:
according to the second weld seam image, determining a remaining area to be filled of the ith weld layer as a target area and a height of the welded weld pass of the ith weld layer as a first target height;
determining a second target height as a maximum value among the first target heights, wherein the second target height is a welding height of the remaining weld passes of the ith weld layer;
according to the target area and the second target height, determining a number of the weld passes remaining in the ith weld layer, welding paths of the remaining weld passes, and welding operation parameters of the remaining weld passes, so as to obtain target parameters; and
modifying corresponding parameters in the first welding strategy as the target parameters, so as to obtain the second welding strategy.

8. The method according to claim 7, wherein the ith weld layer is a filling layer or a capping layer of the weld seam.

9. The method according to claim 2, wherein the first control step comprises:
controlling the welding device to operate according to the welding operation parameters, and to weld the 1st weld pass of the ith weld layer along the welding path from the welding start point coordinate.

10. The method according to claim 1, wherein
before the first determination step, the method further comprises: establishing an initial welding strategy according to weld seam size information of the weld seam before multi-layer multi-pass welding, wherein the initial welding strategy comprises the number of weld layers of the weld seam, a number of weld passes of the weld seam, a welding path of each weld pass of the weld seam, and welding operation parameters of each weld pass of the weld seam; and
the first determination step comprises: before the ith weld layer of the weld seam is welded, adjusting the initial welding strategy according to the first weld seam image, so as to obtain the first welding strategy.

11. (canceled)

12. (canceled)

13. A processor, configured to operate a program, wherein the method according to claim 1 is executed when the program is operated.

14. A welding system, comprising:
a welding device; and
a controller of the welding device, wherein the controller is communicatively connected or electrically connected to the welding device, and comprises one or more processors, a memory, and one or more programs, wherein the one or more programs are stored in the memory, and are configured to be executed by the one or more processors; and the one or more programs comprise instructions for executing the method according to claim 1.

15. The method according to claim 3, wherein according to the first weld seam image, determining the angle information comprising the left groove angle and the right groove angle, and the internal height of the remaining weld seam comprises:
performing centerline extraction on the first weld seam image to obtain a laser centerline, coordinates of two bottom inflection points in the image, and coordinates of two top inflection points in the image;
according to the laser centerline, the coordinates of the two bottom inflection points in the image, and the coordinates of the two top inflection points in the image, determining the left groove angle, the right groove angle, a spacing between the two top inflection points in the image, and an area to be filled of the remaining weld seam in the image;
according to the left groove angle, the right groove angle, the spacing between the two top inflection points in the image, and the area to be filled of the remaining weld seam in the image, determining a numerical value of the internal height of the remaining weld seam in the image; and
performing coordinate system conversion on the numerical value to obtain the internal height of the remaining weld seam, wherein the coordinate system conversion comprises converting an image coordinate system into a camera coordinate system, and then converting the camera coordinate system into world coordinates.

16. The method according to claim 3, wherein
according to the first height, the maximum penetration depth for each weld, and the minimum penetration depth for each weld, determining the number of the weld layers of the remaining weld seam comprises:
according to the first height, the maximum penetration depth, and the minimum penetration depth, determining a value range of the number of the weld layers; and
determining an integer value as the number of the weld layers of the remaining weld seam from the value range; and
according to the first height and the number of the weld layers of the remaining weld seam, determining the welding height of the ith weld layer as the height of each target weld pass comprises: according to the first height and the number of the weld layers of the remaining weld seam, determining an average welding height of each weld layer.

17. The method according to claim 3, wherein according to the area to be filled of the ith weld layer, the maximum deposition area for each weld, and the minimum deposition area, determining the number of the target weld passes and the area to be filled of each target weld pass comprises:
according to the area to be filled of the ith weld layer, the maximum deposition area for each weld, and the minimum deposition area, determining a value range of the number of the target weld passes;
determining an integer value as the number of the target weld passes from the value range of the number of the target weld passes; and
based on an equal area principle of each target weld pass, and according to the area to be filled of the ith weld layer, and the number of the target weld passes, determining the area to be filled of each target weld pass.

18. The method according to claim 2, wherein
before the first determination step, the method further comprises: establishing an initial welding strategy according to weld seam size information of the weld seam before multi-layer multi-pass welding, wherein the initial welding strategy comprises the number of weld layers of the weld seam, a number of weld passes of the weld seam, a welding path of each weld pass of the weld seam, and welding operation parameters of each weld pass of the weld seam; and
the first determination step comprises: before the ith weld layer of the weld seam is welded, adjusting the initial welding strategy according to the first weld seam image, so as to obtain the first welding strategy.

19. The method according to claim 7, wherein according to the target area and the second target height, determining the number of the weld passes remaining in the ith weld layer, welding paths of the remaining weld passes, and the welding operation parameters of the remaining weld passes, so as to obtain the target parameters comprises:
according to the target area, a maximum deposition area for each weld, and a minimum deposition area, determining the number of the weld passes remaining in the ith weld layer;
according to the number of the weld passes remaining in the ith weld layer and the target area, determining a weld pass area of each remaining weld pass;
according to the weld pass area of each remaining weld pass and the second target height, determining a length of an upper bottom edge of each remaining weld pass and a length of an lower bottom edge of each remaining weld pass;
according to the length of the upper bottom edge of each remaining weld pass and the length of the lower bottom edge of each remaining weld pass, determining a welding path of each remaining weld pass, comprising a welding start point coordinate and a welding end point coordinate; and
according to the weld pass area of each remaining weld pass, a welding speed range of the welding device, and a wire feeding speed range, determining the welding operation parameters corresponding to each remaining weld pass.

20. The method according to claim 1, wherein the welding operation parameters comprise a welding speed, a wire feeding speed, and a heat input amount.

21. The method according to claim 2, wherein, the second control step comprises:
a first control sub-step: according to the second welding strategy, controlling the welding device to weld the current weld pass, wherein the welded current weld pass is the previous weld pass;
a determination sub-step: determining whether the previous weld pass is a last weld pass of the ith weld layer; and
a repetition sub-step: when the previous weld pass is not the last weld pass, sequentially executing the first adjustment step, the first control sub-step, and the determination sub-step for at least once, until the previous weld pass is the last weld pass.

22. The method according to claim 3, wherein, the second control step comprises:
a first control sub-step: according to the second welding strategy, controlling the welding device to weld the current weld pass, wherein the welded current weld pass is the previous weld pass;
a determination sub-step: determining whether the previous weld pass is a last weld pass of the ith weld layer; and
a repetition sub-step: when the previous weld pass is not the last weld pass, sequentially executing the first adjustment step, the first control sub-step, and the determination sub-step for at least once, until the previous weld pass is the last weld pass.
